(19) United States
(12) Patent Application Publication
(10) Pub. No.: US 2026/0052046 A1
(43) Pub. Date: Feb. 19, 2026

(54) BACKSCATTER FORWARD LINK ENHANCEMENTS

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Wei YANG, San Diego, CA (US); Huilin XU, Temecula, CA (US); Layne THOMAS, Coronado, CA (US); Peter GAAL, San Diego, CA (US); Wanshi CHEN, San Diego, CA (US); Kianoush HOSSEINI, San Diego, CA (US); Tingfang JI, San Diego, CA (US); Linhai HE, San Diego, CA (US); Yu ZHANG, San Diego, CA (US)

(21) Appl. No.: 19/101,553

(22) PCT Filed: Sep. 20, 2022
(86) PCT No.: PCT/CN2022/119800

§ 371 Date: Feb. 5, 2025

(51) Int. Cl. H04L 25/49

(52) U.S. Cl. CPC H04L 25/4902

(57) ABSTRACT

Certain aspects of the present disclosure provide techniques for backscatter forward link enhancements. An example method performed by a first wireless communication device includes transmitting radio frequency (RF) signals to a second wireless communication device, the RF signals including a plurality of energy pulses encoded, using an encoding scheme, to indicate binary values, and taking one or more actions to maintain a time-averaged voltage associated with the RF signals within a threshold range.

### BACKGROUND

### Field of the Disclosure

Aspects of the present disclosure relate to wireless communications, and more particularly, to techniques for backscatter forward link enhancements.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first wireless communication device. The method includes transmitting radio frequency (RF) signals to a second wireless communication device, the RF signals including a plurality of energy pulses encoded, using an encoding scheme, to indicate binary values; and taking one or more actions to maintain a time-averaged voltage associated with the RF signals within a threshold range.

Another aspect provides a method for wireless communication by a second wireless communication device. The method includes receiving RF signals from a first wireless communication device, the RF signals including a plurality of energy pulses encoded, using an encoding scheme, to indicate binary values; and taking one or more actions to maintain a time-averaged voltage associated with the RF signals within a threshold range.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a radio frequency identification system.

FIG. 6 provides an illustration of Manchester encoding.

FIG. 7 depicts an example of pulse interval encoding.

FIG. 8A illustrates an example circuit for envelope detection.

FIG. 8B illustrates an example amplitude modulated radio frequency signal.

FIG. 8C includes a signal diagram illustrating inputs to a comparator.

FIG. 9 illustrates a radio frequency signal associated with pulse interval encoding and fluctuations in a time-averaged voltage.

FIG. 10 depicts a process flow illustrating operations for communications in a network between a first communication device and a second communication device.

FIG. 11 depicts a specialized symbol for maintaining a time-averaged voltage within a threshold range.

FIG. 12 illustrates use of radio frequency ON/OFF flipping to maintain a time-averaged voltage within a threshold range.

FIG. 13A depicts an example circuit for adjusting a time-averaged voltage.

FIG. 13B depicts an example of performing voltage adjustment before a voltage fluctuation occurs.

FIG. 14 depicts an example of a (DC)-balanced encoding scheme.

FIG. 15 depicts an example linear feedback shift register circuit for performing data whitening.

FIG. 16 depicts an example circuit including an envelope detector.

FIG. 17 depicts a method for wireless communications.

FIG. 18 depicts a method for wireless communications.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for backscatter forward link enhancements.

In some cases, certain devices known as zero power passive internet of things (ZP-IoT) devices may be capable of harvesting energy from one or more wireless energy sources, such as RF signals, thermal energy, solar energy, etc. In some cases, when RF signals are used for energy harvesting in ZP-IoT communication, a first device, such as a reader device, may transmit an energy signal to a second device, such as a ZP-IoT device. The second device may then harvest energy from the energy signal (e.g., using energy harvesting circuitry) and use this harvested energy to power one or more other components of the second device. After a sufficient amount of energy is accumulated, the second device may begin to modulate the energy signal with transmission bits and transmit the energy signal back to the first device, known as a backscatter signal or backscatter communication.

In some cases, the RF signals used for energy harvesting for ZP-IoT communication may be encoded using an encoding scheme, such as pulse interval encoding (PIE). In general, PIE is an encoding technique that encodes binary values (e.g., 0 or 1) into energy pulses using different RF ON and RF OFF durations, resulting in the energy pulses having different pulse widths. For example, in some cases, a bit value of one (e.g., 1) may be indicated using an energy pulse having a long ON duration and a short OFF duration while a bit value of zero (e.g., 0) may be indicated using an energy pulse having a short ON duration and short OFF duration. In some cases, the OFF duration associated with the bit value of one (e.g., 1) may be same length as the OFF duration of the bit value of zero.

In some cases, when the PIE encoding scheme is used to determine whether a received energy pulse in an RF signal corresponds to a bit value of one or a bit value of zero, a receiver (e.g., a ZP-IoT device) may compare a voltage of the received energy pulse against a time-averaged voltage or decision threshold. For example, when the voltage of the received energy pulse is greater than or equal to the time-averaged voltage or decision threshold, the receiver may conclude that the energy pulse corresponds to a bit value of one whereas when the voltage of the received energy pulse is below the time-averaged voltage the receiver may conclude that the energy pulse corresponds to a bit value of zero.

Each received energy pulse may contribute to the time-averaged voltage, which can be problematic in certain scenarios when using the PIE encoding scheme. For example, when energy pulses having a same pulse width (e.g., same binary bit value) are transmitted contiguously, these contiguous energy pulses may cause the time-averaged voltage or decision threshold to fluctuate significantly. Fluctuations in the time-averaged voltage may cause the receiver to improperly determine the bit values corresponding to received energy pulses, damaging decoding performance. For example, improper determinations of the bit values corresponding to received energy pulses may result in messages being received incorrectly. Incorrectly received messages may cause retransmissions to be necessary, resulting in increased latency and wasted time, frequency, and power resources.

Accordingly, aspects of the present disclosure provide mechanisms and techniques for maintaining the time-averaged voltage used as the decision threshold for determining bit values corresponding to received energy pulses. In some cases, these techniques for maintaining the time-averaged voltage may involve using specialized symbols in place of energy pulses to avoid or reduce fluctuations in the time-averaged voltage. In other cases, the techniques for maintaining the time-averaged voltage may involve transmitting an indication for a receiver to adjust the time-averaged voltage to avoid or reduce fluctuations in the time-averaged voltage. In some cases, by maintaining the time-averaged voltage, decoding performance may be improved for ZP-IoT devices. By doing so, the increased latency and wasted time, frequency and power resources that result from incorrectly received messages may be avoided. This may improve quality of service (QOS) performance metrics, reduce overall cost of deployment, and facilitate development of a wide range of useful applications.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

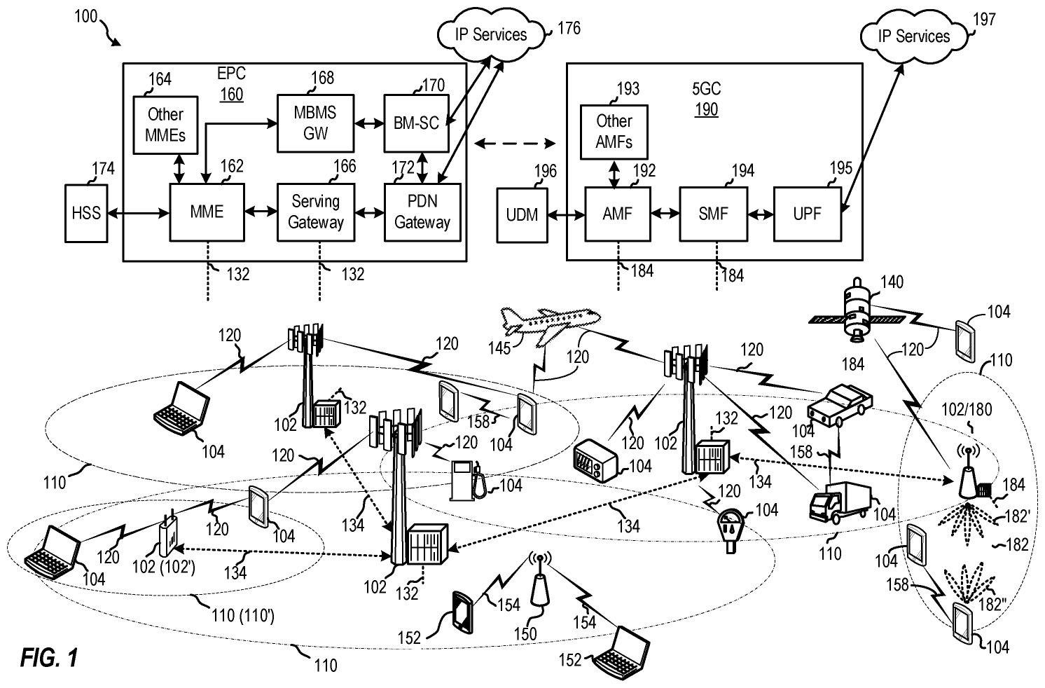

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′may have a coverage area 110′that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

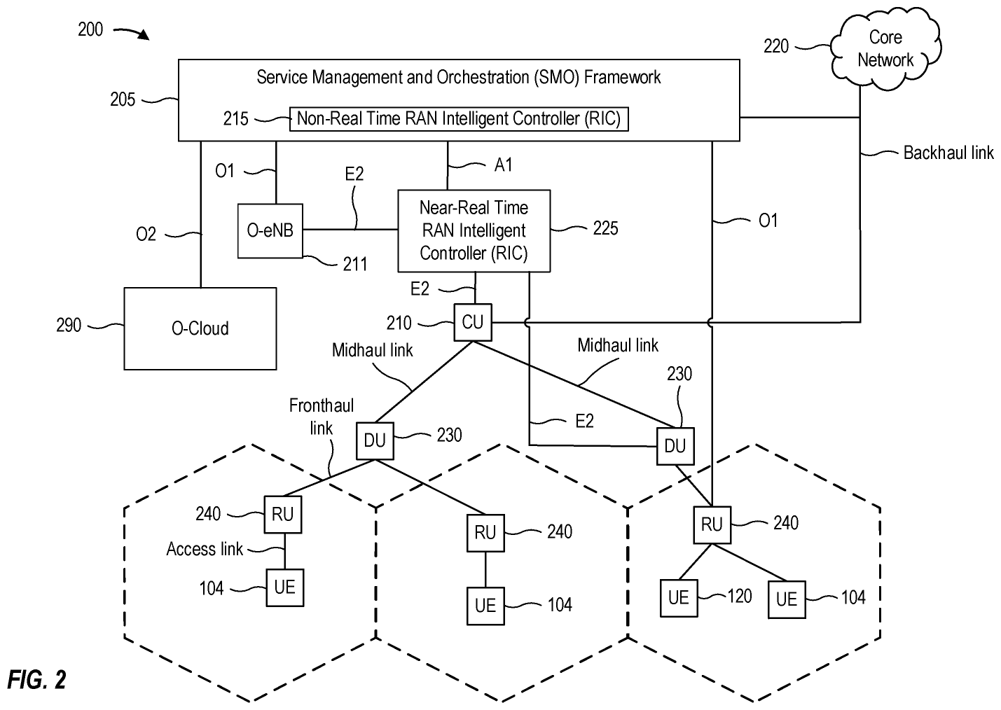

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

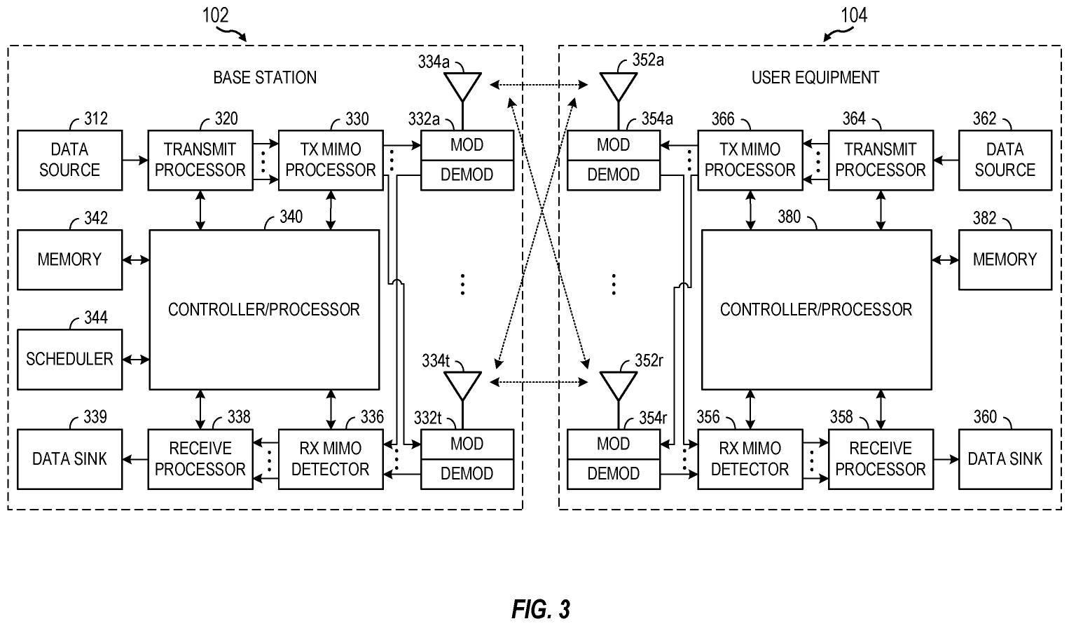

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

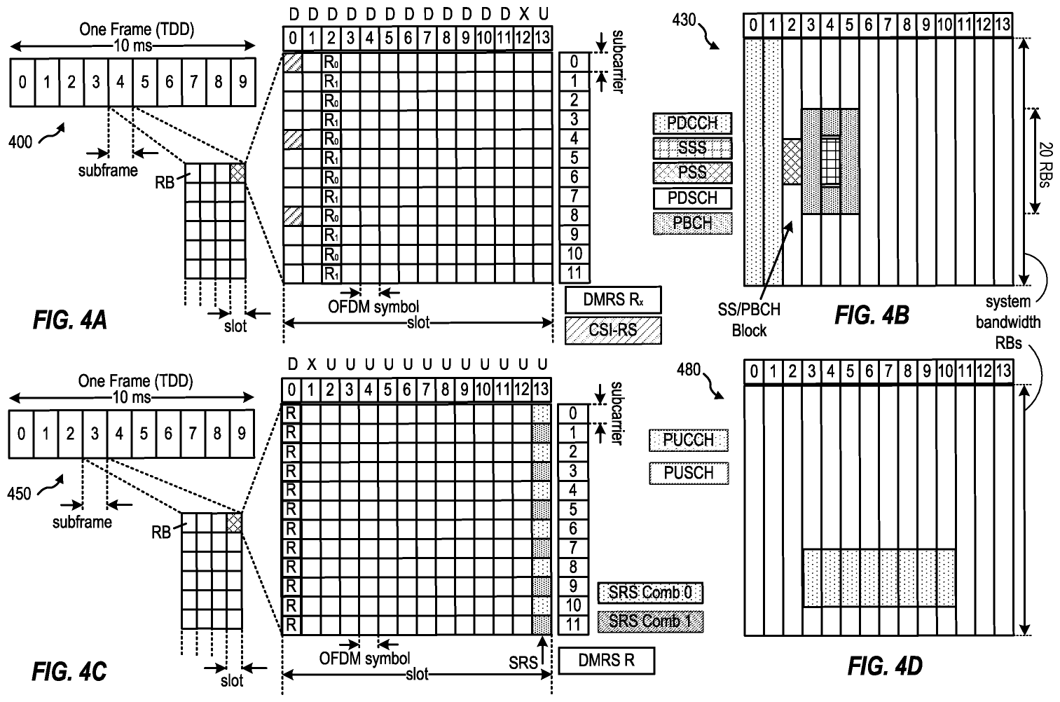

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology p=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in Radio Frequency Identification Systems

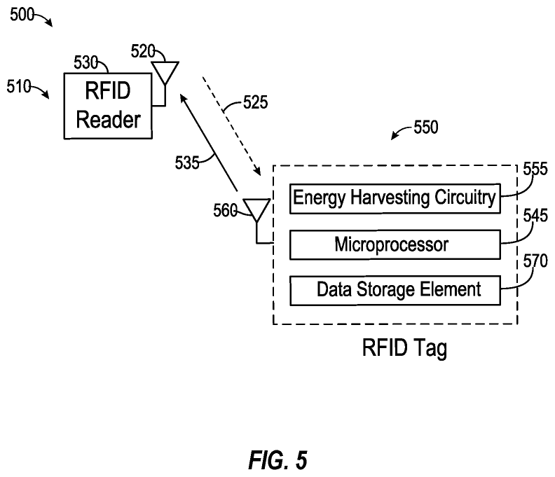

FIG. 5 shows a radio frequency identification (RFID) system 500. As shown, the RFID system 500 includes an RFID reader 510 and an RFID tag 550. The RFID reader 510 may also be referred to as an interrogator or a scanner. The RFID tag 550 may also be referred to as an RFID label or an electronics label.

The RFID reader 510 includes an antenna 520 and an electronics unit 530. The antenna 520 radiates signals transmitted by the RFID reader 510 and receives signals from RFID tags and/or other devices. The electronics unit 530 may include a transmitter and a receiver for reading RFID tags such as the RFID tag 550. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by the RFID reader 510.

As shown, the RFID tag 550 includes an antenna 560 and a data storage element 570. The antenna 560 radiates signals transmitted by the RFID tag 550 and receives signals from the RFID reader 510 and/or other devices. The data storage element 570 stores information for the RFID tag 550, for example, in an electrically erasable programmable read-only memory (EEPROM) or another type of memory. The RFID tag 550 may also include an electronics unit that can process the received signal and generate the signals to be transmitted. The RFID tag 550 may be a passive RFID tag having no battery. In this case, induction may be used to power the RFID tag 550. For example, in some cases, a magnetic field from a signal transmitted by RFID reader 510 may induce an electrical current in RFID tag 550, which may then operate based on the induced current. The RFID tag 550 can radiate its signal in response to receiving a signal from the RFID reader 510 or some other device.

In one example, the RFID tag 550 may be read by placing the RFID reader 510 within close proximity to the RFID tag 550. The RFID reader 510 may radiate a first signal 525 via the antenna 520. In some cases, the first signal 525 may be known as an interrogation signal or energy signal. In some cases, energy of the first signal 525 may be coupled from the RFID reader antenna 520 to RFID tag antenna 560 via magnetic coupling and/or other phenomena. In other words, the RFID tag 550 may receive the first signal 525 from RFID reader 510 via antenna 560 and energy of the first signal 525 may be harvested using energy harvesting circuitry 555 and used to power the RFID tag 550.

For example, energy of the first signal 525 received by the RFID tag 550 may be used to power a microprocessor 545 of the RFID tag 550. The microprocessor 545 may, in turn, retrieve information stored in a data storage element 570 of the RFID tag 550 and transmit the retrieved information via a second signal 535 using the antenna 560. For example, in some cases, the microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to the RFID reader 510. The RFID reader 510 may receive the second signal 535 from the RFID tag 550 via antenna 520 and may process (e.g., demodulate) the received signal to obtain the information of the data storage element 570 sent in the second signal 535.

In some cases, the RFID system 500 may be designed to operate at 13.56 MHz or some other frequency (e.g., an ultra-high frequency (UHF) band at 900 MHz). The RFID reader 510 may have a specified maximum transmit power level, which may be imposed by the Federal Communication Commission (FCC) in the United Stated or other regulatory bodies in other countries. The specified maximum transmit power level of the RFID reader 510 may limit the distance at which RFID tag 550 can be read by RFID reader 510.

### Aspects Related to Enhancements for Backscatter Forward Link Communication

Wireless technology is increasingly useful in industrial applications, such as ultra-reliable low-latency communication (URLLC) and machine type communication (MTC). In such domains, and others, it is desirable to support devices that are capable of harvesting energy from alternative energy sources (e.g., in lieu of or in combination with a battery or other energy storage device, such as a capacitor). For example, in some cases, these devices may not include a local power storage component and may instead harvest energy from things such as RF signals, thermal energy, solar energy, etc. In some cases, these devices may be known as passive IoT (PIoT) devices or more generally as zero power internet of things (ZP-IoT) devices. ZP-IoT devices may employ RFID-type technology and, as such, may not include a local power source. Instead, ZP-IoT devices may harvest energy from radio signals emitted from a reader device, such as a network entity or a user equipment (UE), for performing data collection, transmission and distributed computing.

ZP-IoT devices may have different use cases. For example, one ZP-IoT use case includes an industrial sensor use case where replacing batteries of communication devices is prohibitively difficult or undesirable (e.g., for safety monitoring or fault detection in smart factories, infrastructures, or environments). Another ZP-IoT use case includes a smart logistics/warehousing use case in which extremely-low cost, small size, maintenance-free, durable, long lifespan communication devices are used, for example, for performing automated asset management in factories. Another ZP-IoT use case includes a smart home network for household item management, wearables, and environment monitoring (e.g., a wearable device for medical monitoring where that does not require battery replacement).

As noted above, ZP-IoT devices may be capable of harvesting energy from one or more wireless energy sources, such as RF signals, thermal energy, solar energy, etc. In some cases, when RF signals are used to harvest energy a first device (e.g., BS 102, a disaggregated BS as described with respect to FIG. 2, UE 104, or any other device described herein capable of transmitting wireless signals), may transmit an energy signal to a second device, such as a ZP-IoT device (e.g., UE 104, RFID tag 550, etc.). The second device may then harvest energy from the energy signal (e.g., using energy harvesting circuitry, such as energy harvesting circuity 555 illustrated in FIG. 5) and use this harvested energy to power one or more other components of the second device. In some cases, a portion of the harvested energy may be used to charge a local energy storage device of the second device for later use (i.e., the harvested energy may be stored in the local power storage component). After a sufficient amount of energy is accumulated, the second device may begin to reflect the energy signal radiated onto the second device, known as a backscatter signal or backscatter communication. When reflecting the energy signal, the second device may modulate a particular on-off pattern, corresponding to a set of transmission bits, onto the energy signal. The first device or a third device (e.g., a reader device) may detect and demodulates the reflected pattern, thereby obtaining the set of transmission bits.

In some cases, the RF signals used for energy harvesting for ZP-IoT communication may be encoded using an encoding scheme. In some cases, the encoding scheme may include a Manchester encoding scheme, a pulse interval encoding (PIE) scheme, or another encoding scheme used for RFID-based communication.

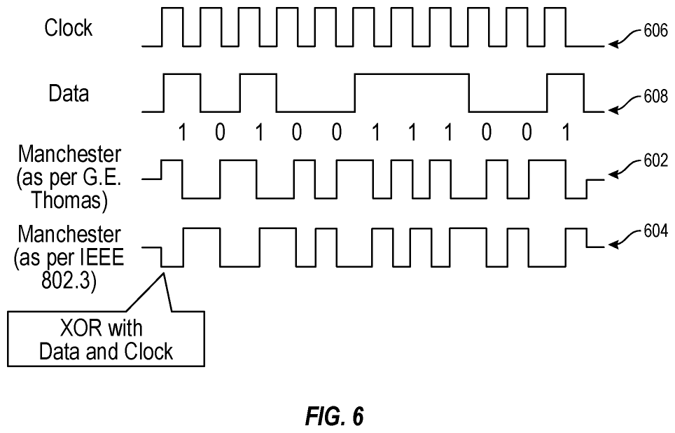

FIG. 6 provides an illustration of Manchester encoding. In Manchester encoding, each data bit may be represented by an energy pulse transition from either a “low” voltage (e.g., 0 or “OFF”) to a “high” voltage (e.g., 1 or “ON”) (e.g., low-to-high) or from a high voltage to a low voltage (e.g., high-to-low). An amount of time at which the energy pulse remains high or low may be equal. In this manner, Manchester encoding guarantees an ON duty cycle of 50%. Manchester encoding also has a constant average DC power and can be supported for RFID communication with a semi-passive tag.

In some cases, different types of Manchester encoding may be used. For example, as shown at 602 in FIG. 6, a first type of Manchester encoding uses a G.E. Thomas convention of Manchester encoding in which a transition from “1” to “0” (high-to-low) encodes a data bit value of “1” and a transition from '0″ to “1″ (low-to-high) encodes a data bit value of ”0″. This first type of Manchester encoding involves an exclusive NOR (XNOR) logical operation between a data signal 608 (e.g., including data bits for encoding) and a clock signal 606. For example, as shown at 602, when a bit value of 1 in the data signal 608 is to be transmitted, this bit value of 1 may be encoded using the first type of Manchester encoding and represented by a transition from high-to-low. When a bit value of 0 in the data signal 608 is to be transmitted, this bit value of 0 may be encoded using the first type of Manchester encoding and represented by a transition from low-to-high.

A second type of Manchester encoding is shown at 604 in FIG. 6. The second type of Manchester encoding uses an Institute of Electrical and Electronics Engineers (IEEE) 802.3 convention of Manchester encoding in which a transition from “1″ to ”0″ (high-to-low) encodes a data bit value of “0” and a transition from “0” to “1” (low-to-high) encodes a data bit value of “1”. This second type of Manchester encoding involves an exclusive OR (XOR) operation performed between the data signal 608 and the clock signal 606. For example, as shown at 604, when a bit value of 1 in the data signal 608 is to be transmitted, this bit value of 1 may be encoded using the second type of Manchester encoding and represented by a transition from low-to-high. When a bit value of 0 in the data signal 608 is to be transmitted, this bit value of 0 may be encoded using the second type of Manchester encoding and represented by a transition from high-to-low.

In some cases, Manchester encoding schemes may be supported for RFID-based communication by semi-passive tags. Semi-passive tags (also called battery-assisted passive tags) are based on the same principle as passive tags, but they include a battery that helps to extend the communication range and tag memory. In some cases, semi-passive tags may also include sensors. However, since Manchester encoding maintains a constant average DC power, it may not be supported by RFID with a passive tag, such as a ZP-IoT device. For example, as noted above, Manchester encoding only guarantees a 50% “ON” duty cycle, which may not be sufficient to supply the necessary energy to power passive tags (e.g., the higher ON duty cycle, the more energy that may be harvested and used to power the passive tag).

Accordingly, to help avoid the issues with Manchester encoding, another type of encoding scheme that may be used is PIE encoding, as noted above. PIE is an encoding technique that encodes binary bit values (e.g., 0 or 1) into energy pulses using different RF ON and RF OFF durations, resulting in the energy pulses having different pulse widths. In some cases, PIE can guarantee at least a 63% “ON” duty cycle, which provides significantly more energy to passive tags. Using PIE may be advantageous for RFIDs with passive tags, since a higher percentage “ON” duty cycle may provide more energy for the passive tag to harvest and use.

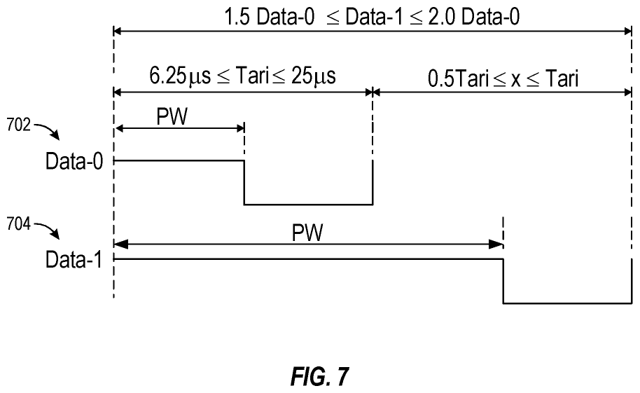

FIG. 7 depicts an example of PIE encoding that may be used for RFID-based communication. As shown, when using PIE encoding, binary bit values (e.g., 1 and 0) may be represented using variable pulse widths, which may be controlled by a Tari value, which defines a given minimum pulse duration or interval, and an x value parameter, which defines a difference in pulse duration between the binary bit values 1 and 0.

For example, as shown at 704 in FIG. 7, a bit value of one (e.g., 1) may be indicated or represented using an energy pulse having a long ON duration and a short OFF duration. Conversely, as shown at 702, a bit value of zero may be indicated using an energy pulse having a short ON duration and short OFF duration. In other words, a pulse width (PW) of an ON duration associated with a bit value of 1 may be longer than a pulse width of an ON duration associated with a bit value of 0. In some cases, as shown, the OFF duration associated with the bit value of one may be same length as the OFF duration of the bit value of zero.

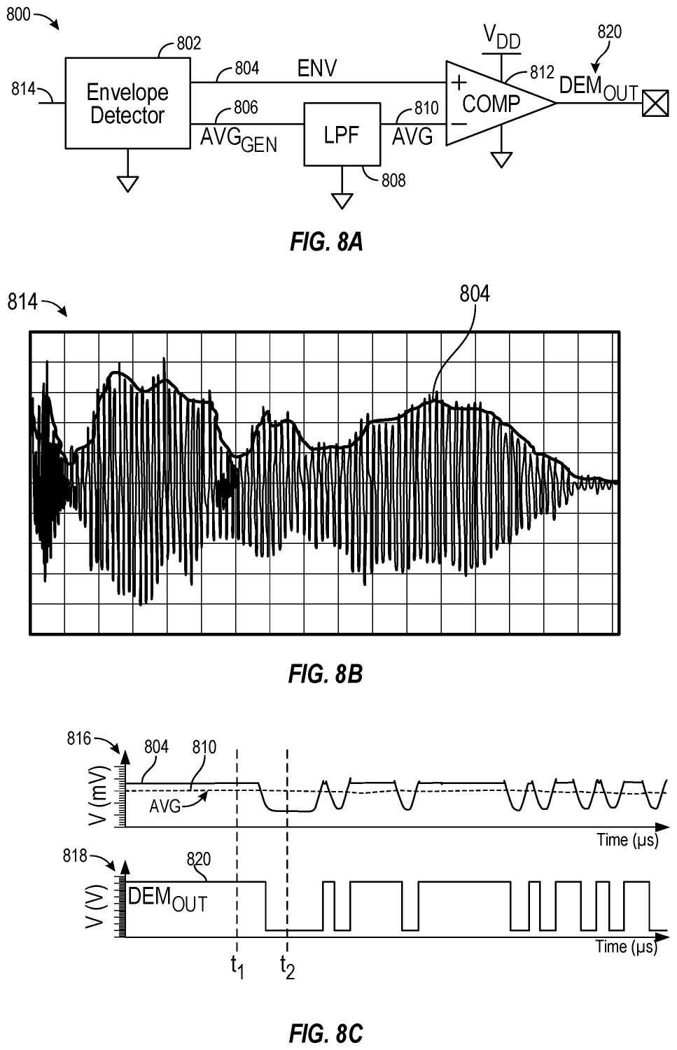

When data bits are transmitted over a wireless channel and received by a passive device, such as a ZP-IoT device, the ZP-IoT device may need to perform a 0-1 decision-making procedure to determine whether received energy pulses are high (e.g., 1) or low (e.g., 0). This 0-1 decision-making procedure is described with respect to FIGS. 8A, 8B, and 8C.

For example, FIG. 8A illustrates an example circuit 800 that may be used for envelope detection and 0-1 decision-making. As shown, the circuit 800 includes an envelope detector 802, which may be configured to receive an amplitude modulated RF signal 814. The envelope detector 802 may then perform envelope detection on the received amplitude modulated RF signal 814 and output an envelope signal 804 and an average generated output signal (AVGGEN) 806. The envelope signal 804 includes a plurality of energy pulses and represents an instantaneous voltage of the received amplitude modulated RF signal 814 while the average generated output signal 806 represents a time-averaged receive voltage for signals received by the envelope detector 802.

As shown, the average generated output signal 806 may be input into a low pass filter (LPF) 808. The LPF 808 is a filter that passes signals with a frequency lower than a selected threshold frequency and attenuates signals with frequencies higher than the threshold frequency. The exact frequency response of the filter may depend on the particular filter design (e.g., the selected threshold frequency). As shown in FIG. 8A, the LPF 808 takes the average generated output signal 806 from the envelope detector 802 as input, and it outputs a time-averaged voltage 810 having frequencies that are higher than a threshold frequency attenuated. The circuit 800 also includes a comparator 812. As shown in FIG. 8A, the comparator 812 is configured to receive envelope signal 804 (e.g., instantaneous voltage) of the envelope detector 802 and output (e.g. the time-averaged voltage 810) of the LPF 808 as inputs. The comparator 812 may then compare the envelope signal 804 to the time-averaged voltage 810 to perform 0-1 decision-making regarding energy pulses in the envelope signal 804 and output a demodulated signal 820.

FIG. 8B illustrates an example amplitude modulated RF signal 814 that may be received by the circuit 800 illustrated in FIG. 8A. As shown, in order to represent binary bit values (e.g., 0 and 1), an amplitude of the amplitude modulated RF signal 814 may vary over time, generating the envelope signal 804 including a plurality of energy pulses and representing an instantaneous voltage of the amplitude modulated RF signal 814. As noted above, this envelope signal 804 may be detected and output by the envelope detector 802, which may then be used by the comparator 812 to perform 0-1 decision-making based on the time-averaged voltage 810 associated with the received amplitude modulated RF signal 814

FIG. 8C includes a first signal diagram 816 illustrating inputs to the comparator 812, such as the envelope signal 804 and the time-averaged voltage 810, and a second signal diagram 818 illustrating the demodulated signal 820 of the comparator 812 after the 0-1 decision-making. As noted above, the comparator 812 may compare the envelope signal 804 to the time-averaged voltage 810 to determine whether an energy pulse in the envelope signal 804 is high or low. More specifically, the comparator 812 may use the time-averaged voltage 810 as a decision threshold for deciding whether an energy pulse in the envelope signal 804 is high or low.

For example, as shown at time t₁ in FIG. 8C, when an energy pulse in the envelope signal 804 (e.g., instantaneous voltage) is greater than the time-averaged voltage 810 (e.g., decision threshold), the comparator 812 is configured to output a “high” signal (e.g., 1). Conversely, as shown at time t₂, when an energy pulse in the envelope signal 804 (e.g., instantaneous voltage) is less than the time-averaged voltage 810, the comparator 812 is configured to output a “low” signal (e.g., 0). Accordingly, as can be seen in FIG. 8C, as time progresses, the demodulated signal 820 develops a pattern of high and low energy pulses having varying widths via which bit values may be encoded using PIE encoding.

In some cases, each received energy pulse in the envelope signal 804 may contribute to the time-averaged voltage 810, which can be problematic in certain scenarios when using the PIE encoding scheme. For example, when energy pulses having a same pulse width (e.g., same binary bit value) are transmitted contiguously, these contiguous energy pulses may cause the time-averaged voltage 810 or decision threshold to fluctuate significantly. Fluctuations in the time-averaged voltage 810 may cause a receiver, such as a ZP-IoT device, to improperly determine the bit values corresponding to received energy pulses, damaging decoding performance. For example, improper determinations of the bit values corresponding to received energy pulses may result in messages being received incorrectly. Incorrectly received messages may cause retransmissions to be necessary, resulting in increased latency and wasted time, frequency, and power resources.

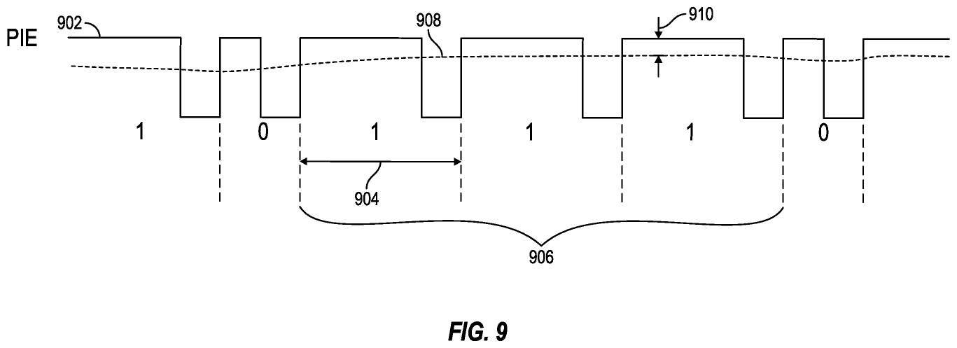

FIG. 9 illustrates a first RF signal 902 associated with PIE encoding and fluctuations in a time-averaged voltage. As shown, the first RF signal 902 includes a plurality of energy pulses used to indicate bit values, as discussed above.

As noted above, certain encoding schemes may be susceptible to fluctuations of the time-averaged voltage when multiple consecutive same energy pulses are transmitted. For example, as illustrated, during the time period 906, three energy pulses having a same pulse width 904 are to be transmitted contiguously. These three energy pulses, as shown, are associated with a bit value of 1, which is indicated in PIE using a long ON duration, as discussed above. As shown, these contiguous long ON durations associated with the three energy pulses causes a duty cycle of the first RF signal 902 to increase. This increased duty cycle of the first RF signal 902, in turn, causes a time-averaged voltage 908 associated with the first RF signal 902 to increase during the time period 906. Further, the increase in the time-averaged voltage 908 during the time period 906 causes a decrease in a noise margin 910 for 0-1 decision-making. This decrease in the noise margin 910 may cause issues with 0-1 decision-making when strong interference is present. For example, this interference may make an instantaneous voltage of an energy pulse associated with a bit value of 1 transmitted in the first RF signal 902 during the time period 906 appear below the time-averaged voltage 908, resulting in an erroneous 0-1 decision-making and this bit value of 1 being interpreted as a 0.

Accordingly, aspects of the present disclosure provide mechanisms and techniques for maintaining the time-averaged voltage used as a decision threshold for determining bit values corresponding to received energy pulses. In some cases, these techniques for maintaining the time-averaged voltage may involve using specialized symbols in place of energy pulses to avoid or reduce fluctuations in the time-averaged voltage. In other cases, the techniques for maintaining the time-averaged voltage may involve transmitting an indication for a receiver to adjust the time-averaged voltage to avoid or reduce fluctuations in the time-averaged voltage. In some cases, by maintaining the time-averaged voltage, decoding performance may be improved for ZP-IoT devices. By doing so, the increased latency and wasted time, frequency and power resources that result from incorrectly received messages may be avoided. This may improve quality of service (QOS) performance metrics, reduce overall cost of deployment, and facilitate development of a wide range of useful applications.

### Example Operations of Entities in a Communications Network

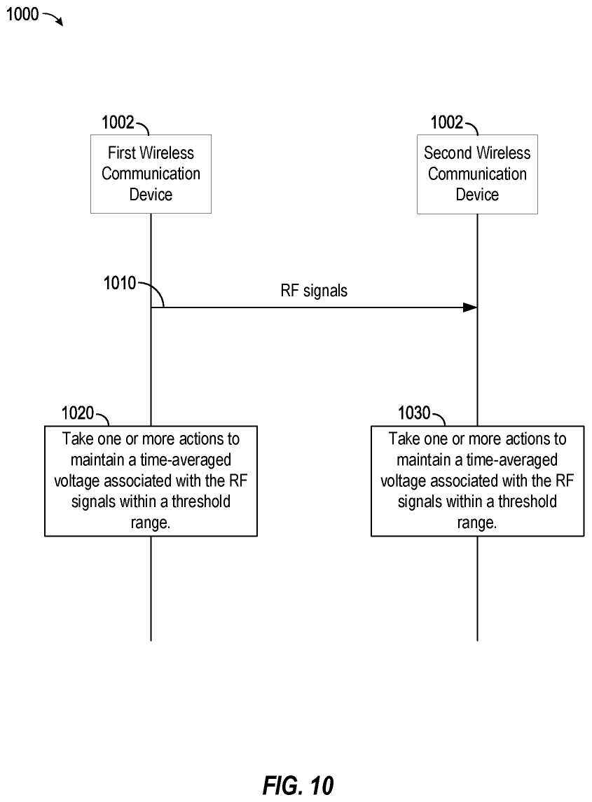

FIG. 10 depicts a process flow illustrating operations 1000 for communications in a network between a first wireless communication device 1002 and a second wireless communication device 1004. In some aspects, the first wireless communication device 1002 may be an example of an RF source device (e.g., a device capable of transmitting RF energy signals), such as BS 102 depicted and described with respect to FIGS. 1 and 3, a disaggregated base station depicted and described with respect to FIG. 2, or the UE 104 depicted and described with respect to FIGS. 1 and 3. Similarly, the second wireless communication device 1004 may be an example of another UE 104 depicted and described with respect to FIGS. 1 and 3 or a ZP-IoT device as described herein, or the RFID tag 550 depicted and described with respect to FIG. 5.

Operations 1000 begin in step 1010 with the first wireless communication device 1002 transmitting RF signals, which may be received by the second wireless communication device 1004. In some cases, the RF signals may include a plurality of energy pulses, encoded using an encoding scheme, to indicate binary values (e.g., 0 or 1). In some cases (e.g., based on the encoding scheme), the energy pulses may have different pulse widths to indicate the binary values (e.g., “0” and “1”). In some cases, the encoding scheme may comprise a PIE scheme.

In step 1020, the first wireless communication device 1002 takes one or more actions to maintain a time-averaged voltage associated with the RF signals within a threshold range. Similarly, in step 1030, the second wireless communication device 1004 takes one or more actions to maintain the time-averaged voltage associated with the RF signals within a threshold range. In some cases, the one or more actions taken in step 1030 by the second wireless communications device to maintain the time-averaged voltage associated with the RF signals may be performed in addition to the one or more steps taken by the first wireless communications device 1002 to maintain the time-averaged voltage associated with the RF signals. In some cases, the one or more actions taken in steps 1020 and 1030 by the first wireless communication device 1002 and second wireless communication device 1004 may be performed prior to or after the RF signals are transmitted in step 1010.

In some cases, the first wireless communication device 1002 may determine that a threshold number (e.g. ≥X) of energy pulses having a same pulse width are to be transmitted contiguously. For example, in some cases, the threshold number of energy pulses having the same pulse width may include a threshold number of energy pulses encoded to represent a bit value of 1 or a threshold number of energy pulses encoded to represent a bit value of 0. In some cases, the threshold number of energy pulses may be dynamically configured or pre-configured. For example, in some cases, when the first wireless communication device 1002 comprises a UE (e.g., UE 104), a network entity (e.g., BS 102) may transmit configuration information to the UE indicating the threshold number of energy pulses. In some cases, when the first wireless communication device 1002 comprises a UE (e.g., UE 104), threshold number of energy pulses may be pre-configured in the first wireless communication device 1002 by a manufacturer or retailer of the first wireless communication device 1002. Similarly, in some cases, the first wireless communication device 1002 may transmit configuration information to the second wireless communication device 1004 indicating the threshold number of energy pulses. In some cases, the threshold number of energy pulses may be pre-configured in the second wireless communication device 1004 by a manufacturer or retailer of the second wireless communication device 1004.

As noted above, when a threshold number of energy pulses having a same pulse width are transmitted contiguously, the time-averaged voltage associated with the RF signals may fluctuate, resulting in a decreased noise margin and a significant increase in the likelihood of erroneous decoding (e.g., faulty 0-1 decision-making) at the second wireless communications device 1004.

In some cases, when the first wireless communication device 1002 determines that the threshold number of energy pulses are to be transmitted contiguously, to reduce fluctuations and maintain the time-averaged voltage associated within the threshold range, taking the one or more actions in step 1020 of FIG. 10 by the first wireless communication device 1002 may include transmitting, to the second wireless communication device 1004 a specialized symbol in the RF signals in place of at least one energy pulse of the threshold number of energy pulses. In some cases, the specialized symbol may be represented by an RF ON duration and an RF OFF duration that are different from the RF ON and RF OFF durations used to represent the bit values zero and one.

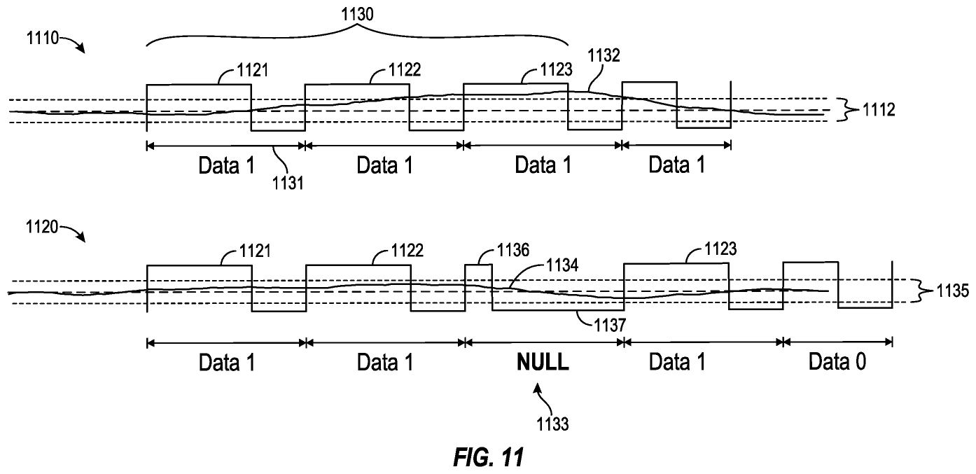

In some cases, as illustrated in FIG. 11, the specialized symbol may comprise a specialized NULL symbol. For example, FIG. 11 includes a first RF signal 1110 and a second RF signal 1120 illustrating the effects of transmitting a specialized symbol, such as a NULL symbol, in place of at least one energy pulse of the threshold number of energy pulses. In the example shown in FIG. 11, the threshold number of energy pulses is configured to be three (e.g., X=3).

As can be seen at 1130, three energy pulses 1121, 1122, and 1123 having a same pulse width 1131 (e.g., representing a bit value of 1) are scheduled to be transmitted contiguously in the first RF signal 1110. However, while three energy pulses 1121, 1122, and 1123 are scheduled to be transmitted contiguously in the first RF signal 1110, a specialized symbol is not transmitted within the first RF signal 1110. As a result, a time-averaged voltage 1132 associated with the first RF signal 1110 exceeds the threshold range 1112 (e.g., due to the increased duty cycle associated with the bit values of 1), which can lead to decoding performance degradation at the second wireless communication device 1004.

In second RF signal 1120 in FIG. 11, however, the first wireless communication device 1002 transmits a NULL symbol 1133 in order to maintain a time-averaged voltage 1134 within a threshold range 1135. For example, as shown, the NULL symbol 1133 is transmitted in place of the transmission of the energy pulse 1123, as compared to the first RF signal 1110. As a result, the NULL symbol 1133 may be transmitted between the energy pulse 1122 and the energy pulse 1123, allowing the time-averaged voltage 1134 to be maintained within the threshold range 1135.

As shown, the NULL symbol 1133 may comprise an energy pulse having a relatively short ON duration 1136 followed by a relatively long OFF duration 1137. In some cases, the relatively long OFF duration 1137 may be configured to counteract any increase in the time-averaged voltage 1134 due to a long ON duration associated with the energy pulses 1121, 1122, and 1123 used for indicating the bit value of 1. As a result, a larger noise margin may be maintained, decreasing the likelihood of erroneous 0-1 decision-making by a comparator (e.g., comparator 812) of the second wireless communication device 1004.

It should be understood that, while the techniques described above for transmitting the specialized symbol in the place of at least one energy pulse of the threshold number of energy pulses are described with respect to contiguously transmitted energy pulses representing the bit value of 1, these techniques apply equally to contiguously transmitted energy pulses representing the bit value of 0.

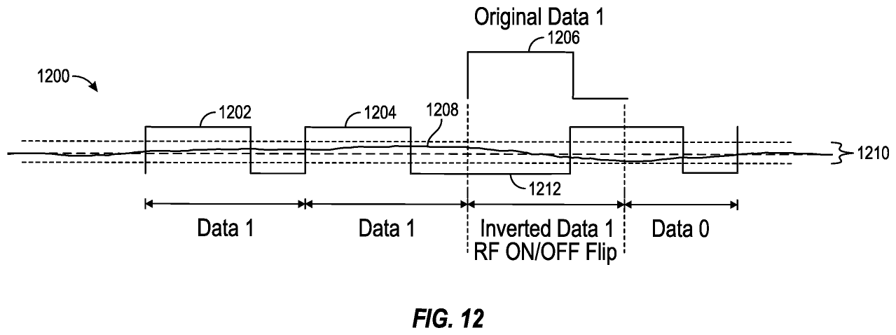

In some cases, transmitting the specialized symbol may comprise transmitting an inverted version of the at least one energy pulse of the threshold number of energy pulses, which may be known as ON/OFF flipping. FIG. 12 illustrates the use of RF ON/OFF flipping to maintain the time-averaged voltage within the threshold range, in accordance with aspects of the present disclosure.

For example, as shown in FIG. 12, three energy pulses 1202, 1204, and 1206 having a same pulse width (e.g., representing a bit value of 1) are scheduled to be transmitted contiguously by the first wireless communication device 1002 in a first RF signal 1200. In this case, instead of transmitting the three energy pulses 1202, 1204, and 1206 contiguously (e.g., which would otherwise cause a time-averaged voltage 1208 of the first RF signal 1200 to exceed a threshold range 1210), the first wireless communication device 1002 “flips” and transmits an inverted version 1212 of the energy pulse 1206. As can be seen, the inverted version 1212 increases an OFF duration of the first RF signal 1200 in order to counteract any increase in the time-averaged voltage 1208 due to a long ON duration associated with the energy pulses 1202, 1204, and 1206, allowing the time-averaged voltage 1208 to be maintained within the threshold range 1210. As a result, a larger noise margin may be maintained, decreasing the likelihood of erroneous 0-1 decision-making by a comparator (e.g., comparator 812) of the second wireless communication device 1004.

It should be understood that, while the contiguous energy pulses 1202, 1204, and 1206 are illustrated as representing bit values of 1, the techniques for transmitting the inverted version apply equally to three contiguous energy pulses representing bit values of 0. For example, in this case, at least one of the energy pulses representing the bit value of 0 may be flipped to an energy pulse representing a bit value of 1.

In some cases, the inverted version 1212 of the energy pulse 1206 may be treated as an information bit or a non-information bit. If the inverted version 1212 of the energy pulse 1206 is treated as an information bit, the inverted version 1212 of the energy pulse 1206 may be modulated to “1” or “0”. If the inverted version 1212 of the energy pulse 1206 is treated as a non-information bit, the inverted version 1212 of the energy pulse 1206 may be discarded after demodulation by the second wireless communication device 1004. In some cases, using such a specialized symbol (e.g., inverted version of an energy pulse) to carry information may facilitate the achievement of a higher data rate, compared to using specialized symbols that carry no information, such as the NULL symbol described with respect to FIG. 11.

In some cases, taking the one or more actions in step 1020 may involve the first wireless communication device 1002 transmitting an indication to the second wireless communication device 1004. In some cases, the indication may indicate to the second wireless communication device 1004 to adjust the time-averaged voltage. In such cases, the second wireless communication device 1004 may take the one or more actions in step 1030 by adjusting the time-averaged voltage based on the indication received from the first wireless communication device 1002 to adjust the time-averaged voltage.

In some cases, the second wireless communication device 1004 may be configured with one or more rules that indicate to the second wireless communication device 1004 to adjust the time-averaged voltage. In some cases, the one or more rules may be sent to the second wireless communication device 1004 in configuration information from the first wireless communication device or may be preconfigured in the second wireless communication device 1004 (e.g., by a manufacturer or retailer of the second wireless communication device 1004). In some cases, the one or more rules may configured the second wireless communication device 1004 to adjust the time-averaged voltage upon receiving a threshold number of contiguous symbols. In other words, rather than receiving an indication from the first wireless communication device 1002 to adjust the time-averaged voltage, the second wireless communication device 1004 may be configured to autonomously adjust the time-averaged voltage when the threshold number of contiguous symbols are received.

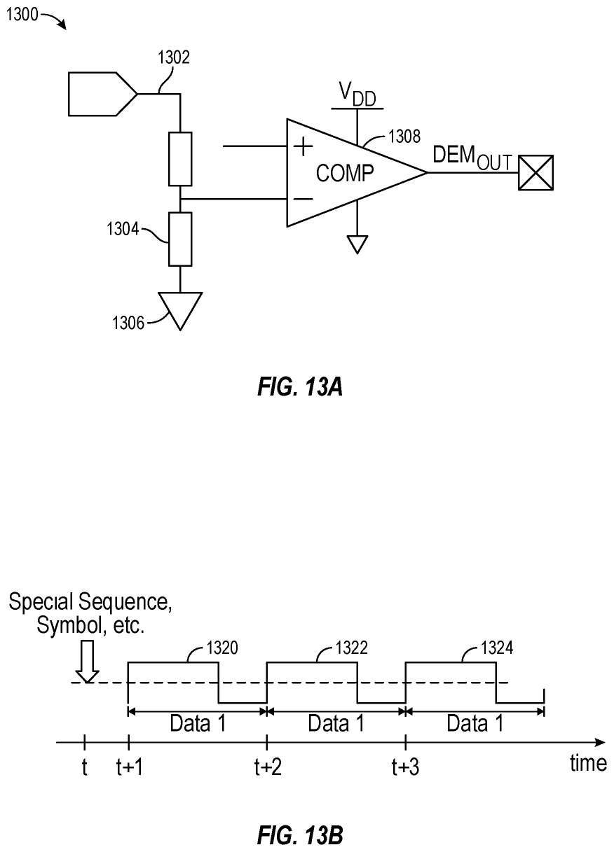

FIG. 13A depicts an example circuit 1300 that may be included in the second wireless communication device 1004 and used to adjust the time-averaged voltage. For example, as shown, a time-averaged voltage 1302 may be input into the circuit 1300. In some cases, in response to receiving an indication to adjust the time-averaged voltage, a switch 1304 may be used to effectively split the time-averaged voltage 1302 between a ground terminal 1306 and a comparator 1308. By splitting the time-averaged voltage 1302 between a ground terminal 1306 and a comparator 1308, the second wireless communication device 1004 may be able to maintain the time-averaged voltage 1302 within the threshold range.

In some cases, the voltage adjustment may be conducted before a voltage fluctuation occurs (e.g., before the threshold number of energy pulses having the same pulse width are transmitted contiguously). For example, in some cases, as illustrated in FIG. 13B, the first wireless communication device 1002 may determine that a threshold number of energy pulses having a same pulse width as each other are to be transmitted contiguously, such as the energy pulses 1320, 1322, and 1324. In such cases, the first wireless communication device 1002 may transmit the indication to the second wireless communication device 1004 to adjust the time-averaged voltage prior to transmitting the threshold number of energy pulses (e.g., the energy pulses 1320, 1322, and 1324). In other words, the indication received from the first wireless communication device 1002 indicates to the second wireless communication device 1004 to adjust the time-averaged voltage prior to receiving the threshold number of energy pulses. For example, as shown, the indication to adjust the time-averaged voltage may be transmitted by the first wireless communication device 1002 at time t, while the energy pulses 1320, 1322, and 1324 are transmitted at times t+1, t+2, and t+3, respectively.

In some cases, the indication to adjust the time-averaged voltage may comprise a specialized symbol or a specialized sequence. For example, in some cases, specialized symbol may comprise an energy pulse having a particular unique pulse width not used for indicating a bit value of 0 or 1. For example, as noted above, in PIE encoding, a bit value of 1 may be indicated using a long ON duration and a short OFF duration while a bit value of 0 may be indicated using a short ON duration and a short OFF duration. As such, in one example, the specialized symbol may comprise an energy pulse having a short ON duration and a long OFF duration or an energy pulse having a long ON duration and a long OFF duration, etc. In other words, as noted, the specialized symbol may comprise any sort of energy pulse so long as it is not interpreted as an energy pulse indicating an existing bit value of 0 or 1.

In some cases, the specialized sequence may comprise a sequence of energy pulses that indicate a particular sequence of bit values. For example, in some cases, the specialized sequence may comprise a sequence of energy pulses indicating a bit value sequence of 010, 011, 110, or any other bit value sequence that may be configured to indicate to adjust the time-averaged voltage.

In some cases, the second wireless communication device 1004 may transmit capability information to the first wireless communication device 1002 indicating an ability of the second wireless communication device 1004 to adjust the time-averaged voltage. In such cases, whether the first wireless communication device 1002 transmits the indication to adjust the time-averaged voltage may be based on the capability information from the second wireless communication device 1004.

In some cases, the capability information may indicate to the first wireless communication device 1002 that the second wireless communication device 1004 does not support adjusting the time-averaged voltage. In such cases, in order to maintain the time-averaged voltage associated with the RF signals transmitted in step 1010 of FIG. 10 within the threshold range, the first wireless communication device 1002 may be configured to dynamically configure the encoding scheme used to indicate binary values. For example, in some cases, when the capability information indicates that the second wireless communication device 1004 device does not support adjusting the time-averaged voltage, taking the one or more actions to maintain the time-averaged voltage associated with the RF signals within the threshold range in step 1020 of FIG. 10 may include dynamically configuring a direct current (DC)-balanced encoding scheme to indicate the binary values (e.g., 0 and 1). Further, in some cases, the first wireless communication device 1002 may transmit an indication to the second wireless communication device 1004 indicating the dynamically configured encoding scheme used for transmitting the RF signals by the first wireless communication device 1002.

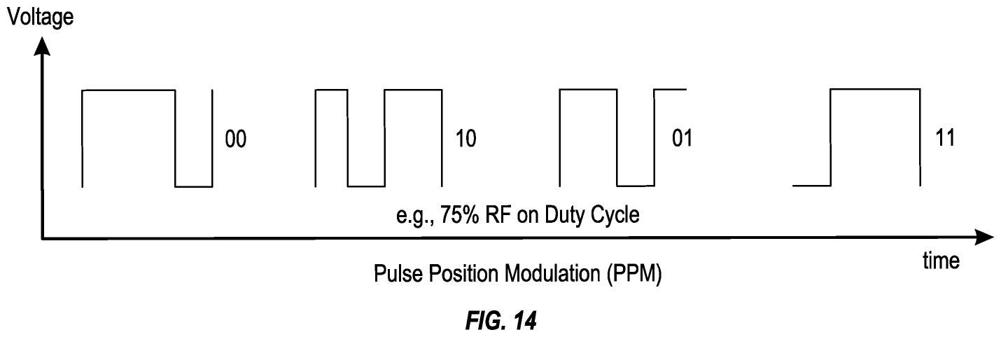

FIG. 14 depicts an example of a DC-balanced encoding scheme. In some cases, fluctuations in the time-averaged voltage may be caused by a difference in RF ON/OFF duty cycles between the binary values 0 and 1. One example of a difference between RF ON/OFF duty cycles may include the case where a 75% RF ON duty cycle and 25% RF OFF duty cycle are used to encode binary bit value 1 while a 50% RF ON and 50% RF OFF duty cycle are used to encode binary bit value 0. As noted, this difference in RF ON/OFF duty cycles between the binary values 0 and 1 may lead to fluctuations in the time-averaged voltage.

As such, in some cases, to avoid these fluctuations, other encoding methods, such as DC-balanced encoding schemes, may be used by the first wireless communication device 1002. In some cases, a DC balanced encoding scheme may have a same RF ON/OFF duty cycle (e.g., RF ON duty cycle==RF OFF duty cycle) for encoding binary bit values 1 and 0. In other cases, a DC balanced encoding scheme may use an RF ON duty cycle that is different than an RF OFF duty cycle for encoding binary bit values 1 and 0. For example, in such cases, the DC balanced encoding scheme may use a 75% RF ON and 25% RF OFF duty cycle to encode binary bit value 1 and use a 75% RF ON and 25% RF OFF duty cycle to encode binary bit value 0.

One such DC-balanced encoding scheme that may be dynamically configured by the first wireless communication device 1002 is illustrated in FIG. 14 and comprises an encoding scheme known as pulse position modulation (PPM). PPM is an encoding scheme in which an amplitude and a width of the energy pulses are kept constant, while the position of each energy pulse, with reference to the position of a reference energy pulse varies according to the instantaneous sampled value of a message signal. As shown in the example of FIG. 14, the encoding scheme is able to achieve an RF ON duty cycle of approximately 75%. While FIG. 14 illustrates one example encoding scheme that may be dynamically configured by the first wireless communication device 1002, other encoding schemes may be dynamically configured, such as PIE, Manchester encoding, or other encoding schemes used for RFID-based communications. In some cases, the first wireless communication device 1002 may configure the second wireless communication device 1004 with the selected encoding method.

In some cases, to avoid the threshold number of energy pulses having a same pulse width (e.g., ≥X 0s or 1s) from being transmitted contiguously, the first wireless communication device may be configured to perform techniques known as data scrambling and/or data whitening. Data scrambling and data whitening may involve multiplying data for transmission (e.g., that may normally result in the threshold number of energy pulses being transmitted contiguously) with a specialized sequence (e.g., that may be dynamically configured or preconfigured). The specialized sequence may be designed to avoid occurrences of the threshold number of energy pulses having the same pulse width from being transmitted in the RF signals. Accordingly, in some cases, taking one or more actions to maintain the time-averaged voltage associated with the RF signals in step 1020 of FIG. 10 may include performing one of data scrambling or data whitening on the RF signals transmitted in step 1010 to avoid a threshold number of energy pulses having a same pulse width being transmitted contiguously.

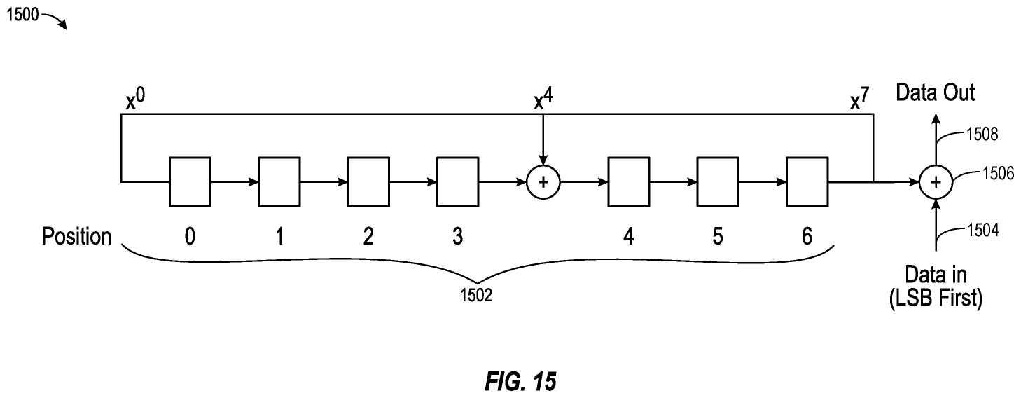

FIG. 15 depicts an example linear feedback shift register (LFSR) circuit 1500 that may be used to perform data whitening. In some cases, the LFSR circuit 1500 may be used to generate a random sequence 1502 of 7 bits (e.g., bits 0-6). This random sequence may then be used to perform an XOR operation 1506 with transmission payload 1504 and a cyclic redundancy check (CRC) checksum. The XOR operation 1506 may be performed starting with the least significant bit of the payload 1504 and progressing to the most significant bit of the payload 1504. The XOR operation 1506 results in whitened data 1508 that may be transmitted by the first wireless communication device 1002 via the RF signals (e.g., transmitted in step 1010 in FIG. 10). After receiving the RF signals including the whitened data 1508, the second wireless communication device 1004 may de-whiten the whitened data 1508 by performing another XOR operation on the whitened data 1508 using the same random sequence 1502.

In some cases, whether data whitening or data scrambling is used by the first wireless communication device 1002 to maintain the time-averaged voltage associated with the RF signals, the random sequences (or how to generate such sequences) used in data whitening or data scrambling may be preconfigured (e.g., known) in advance to both the first wireless communication device 1002 and the second wireless communication device 1004. For example, in some cases, the first wireless communication device 1002 may transmit an indication to the second wireless communication device 1004 indicating the random sequence used by the first wireless communication device 1002 when performing the data whitening or data scrambling associated with data transmitted in the RF signals. In some cases, the random sequence used by the first wireless communication device 1002 when performing the data whitening or data scrambling may assist the second wireless communication device 1004 in properly decoding the RF signals received from the first wireless communication device 1002. In some cases, when the first wireless communication device 1002 comprises a UE (e.g., UE 104), the UE may receive an indication from a network entity (e.g., BS 102) indicating the random sequence(s) to use to perform the data whitening or data scrambling or how to generate the random sequence(s).

In some cases, to maintain the time-averaged voltage within the threshold range, taking the one or more actions in step 1030 by the second wireless communication device 1004 may comprise suspending power averaging of the energy pulses in the RF signals for a particular duration. For example, when a threshold number (e.g., X) of energy pulses having a same pulse width are transmitted contiguously, an envelope detector (e.g., envelope detector 802 illustrated in FIG. 8A) of the second wireless communication device 1004 may be configured to suspend power averaging of the energy pulses in the RF signals for a particular duration (e.g., Y). In some cases, the threshold number (e.g., X) and/or the duration (e.g., Y) may be dynamically configured by the first wireless communication device 1002 to the second wireless communication device 1004 or may be preconfigured (e.g., by a manufacturer or retailer of the second wireless communication device).

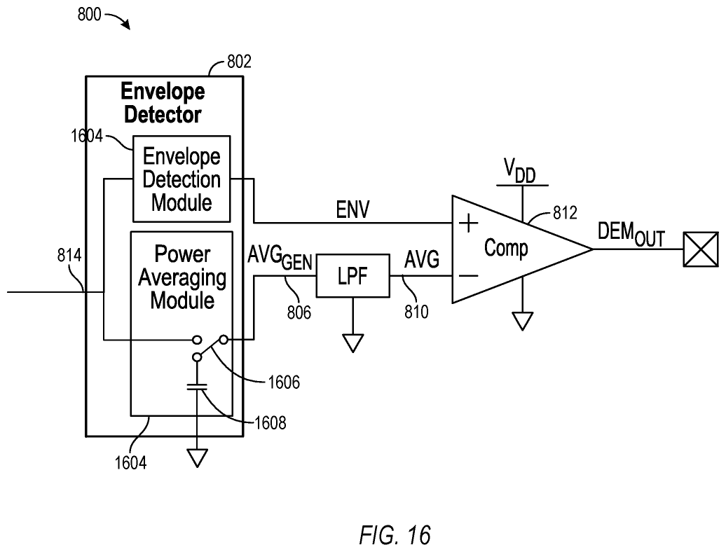

In some cases, a switch may be included within the envelope detector of the second wireless communication device 1004 that may allow the second wireless communication device to suspend the power averaging of the energy pulses for the particular duration. For example, FIG. 16 again illustrates the circuit 800 of FIG. 8A, including the envelope detector 802. As shown, the envelope detector 802 includes an envelope detection module 1602 configured to output the envelope signal 804 and a power averaging module 1604 configured to output the average generated output signal 806. Further, as can be seen, power averaging module 1604 includes a switch 1606. The switch 1606 may allow the power averaging module 1604 of the envelope detector 802 of the second wireless communication device 1004 to suspend the power averaging of the energy pulses received in the RF signals (e.g., amplitude modulated RF signal 814) for a duration. For example, in some cases, when the second wireless communication device 1004 detects the threshold number of energy pulses, the second wireless communication device 1004 may open the switch 1606, preventing additional voltage from received energy pulses from affecting the time-averaged voltage 810 input into the comparator 812, thereby maintaining the time-averaged voltage 810 within the threshold range.

In some cases, when power averaging is suspended, a capacitor may be used to maintain the time-averaged voltage 810 input to the comparator 812. For example, as shown in FIG. 16, the power averaging module 1604 may include a capacitor 1608. When the switch 1606 is “open” and not connected to the amplitude modulated RF signal 814 (e.g., such that energy pulses in the amplitude modulated RF signal 814 are prevented from affecting the time-averaged voltage 810), as illustrated in FIG. 16, the capacitor 1608 may be configured to supply a voltage to maintain the time-averaged voltage 810 within the threshold range. Thereafter, the switch 1606 may be switched back to receiving input from the amplitude modulated RF signal 814.

In some cases, the first wireless communication device 1002 may transmit to the second wireless communication device 1004, in the RF signals, a specialized symbol that indicates to the second wireless communication device to suspend the power averaging of the energy pulses in the RF signals for the duration, In such cases, in response to receiving at least the specialized symbol from the first wireless communication device 1002, the second wireless communication device 1004 may suspend power averaging for the indicated duration (e.g., in some cases using the switch 1606). As noted above, transmissions with a greater RF ON duty cycle may provide more energy to a semi-passive/passive RFID device, such as the second wireless communication device 1004. In some cases, when the first wireless communication device 1002 (e.g., a reader) is located close to the second wireless communication device 1004 (e.g., an RFID tag), the first wireless communication device 1002 may be able to provide enough energy, even during a shorter RF ON duration, to the second wireless communication device 1004 for the second wireless communication device 1004 to transmit RF signals back to the first wireless communication device 1002 (e.g., since response power of the second wireless communication device 1004 increases as a distance between the first wireless communication device 1002 and the second wireless communication device 1004 decreases).

Accordingly, in some cases, in addition to being able to dynamically configure the encoding scheme encoding scheme used to indicate binary values, the first wireless communication device 1002 may also be able to dynamically configure a duty cycle or RF ON durations (e.g., pulse width associated with the energy pulses) and RF OFF durations (e.g., between energy pulses) associated with the RF signals. In some cases, the dynamic configuration of RF ON/OFF durations may be based on a distance between the first wireless communication device 1002 and the second wireless communication device 1004. For example, in some cases, the first wireless communication device 1002 may decrease an RF ON duration of the energy pulses in the RF signals transmitted in step 1010 of FIG. 10 as a distance between the first wireless communication device 1002 and the second wireless communication device 1004 decreases. In some cases, the distance between the first wireless communication device 1002 and the second wireless communication device 1004 may be indicated (e.g., implicitly) by parameters (e.g., quality of service (QOS) parameters). For example, an absence of an acknowledgement (ACK) or a negative ACK (NACK), the reception of a NACK, a decoding error, or other parameters or events may indicate distance between the first wireless communication device 1002 and the second wireless communication device 1004. Such indications may be provided as feedback information from the second wireless communication device 1004 (e.g., an RFID tag).

In some cases, the dynamic configuration of RF ON/OFF durations may be based on a response power of the second wireless communication device 1004. For example, in some cases, the first wireless communication device 1002 may measure a response power of the second wireless communication device 1004 based on the RF signals transmitted to the second wireless communication device 1004. In some cases, the response power may comprise a power of RF signals transmitted by the second wireless communication device 1004 in response to the RF signals transmitted in step 1010 of FIG. 10 by the first wireless communication device 1002. In some cases, the first wireless communication device 1002 may then dynamically configure a pulse width (e.g., an ON duration, in some examples) and an OFF duration associated with the plurality of energy pulses in the RF signals transmitted in step 1010 based on the measured response power of the second wireless communication device 1004.

### Example Operations of a First Wireless Communication Device

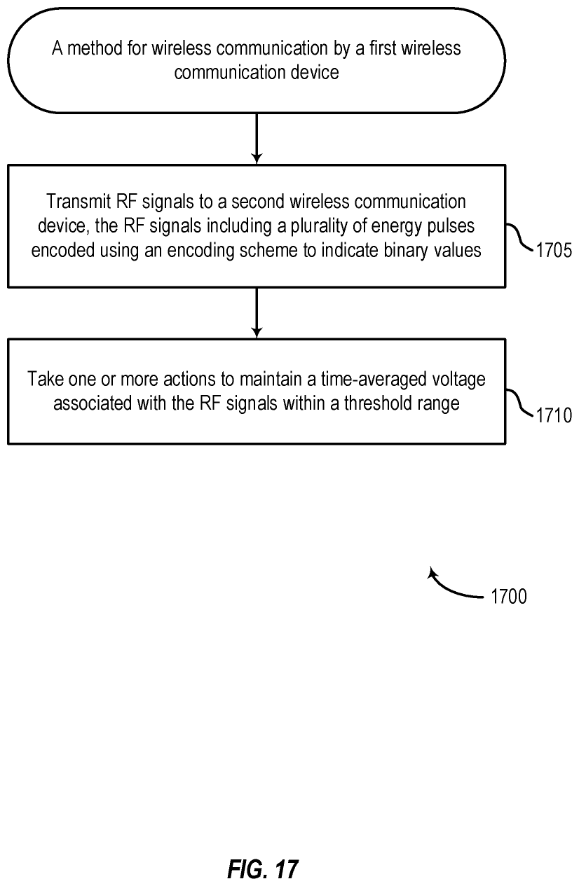

FIG. 17 shows an example of a method 1700 for wireless communication by a first wireless communication device. In some examples, the first wireless communication device is a UE, such as a UE 104 of FIGS. 1 and 3. In some examples, the first wireless communication device is a network entity, such as a BS 102 of FIGS. 1 and 3, or a disaggregated base station as discussed with respect to FIG. 2.

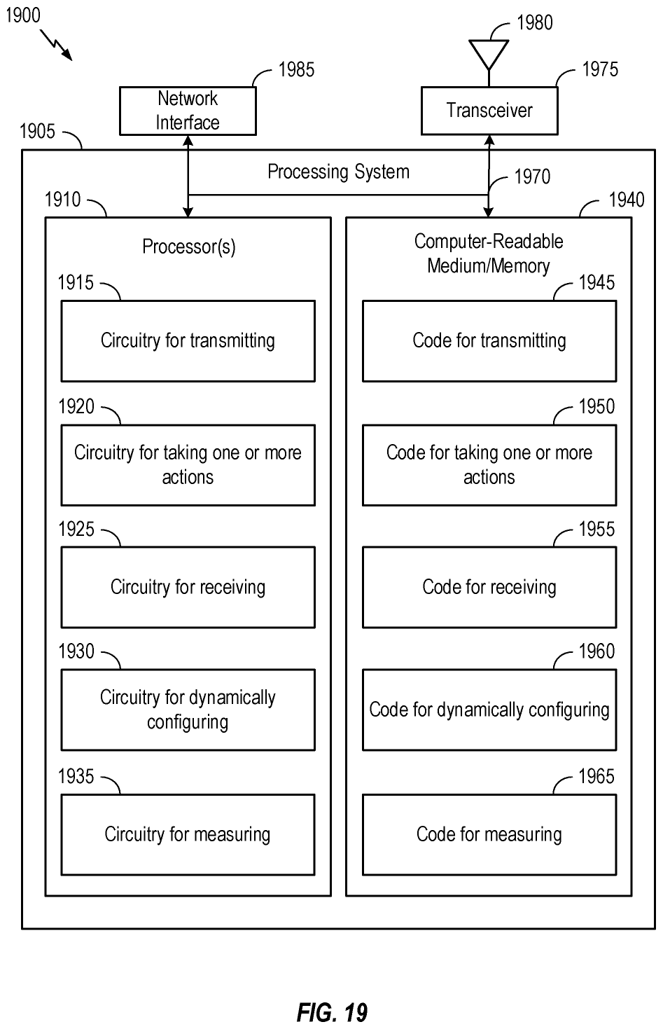

Method 1700 begins at step 1705 with transmitting RF signals to a second wireless communication device, the RF signals including a plurality of energy pulses encoded, using an encoding scheme, to indicate binary values. In some cases, the operations of this step refer to, or may be performed by, circuitry for transmitting and/or code for transmitting as described with reference to FIG. 19.

Method 1700 then proceeds to step 1710 with taking one or more actions to maintain a time-averaged voltage associated with the RF signals within a threshold range. In some cases, the operations of this step refer to, or may be performed by, circuitry for taking and/or code for taking as described with reference to FIG. 19.

In some aspects, based on the encoding scheme, the energy pulses have different pulse widths to indicate the binary values.

In some aspects, the encoding scheme comprises a PIE scheme.

In some aspects, the taking one or more actions comprises: determining that a threshold number of energy pulses having a same pulse width as each other are to be transmitted contiguously; and transmitting, based on the determined threshold number of energy pulses, a specialized symbol in the RF signals in place of at least one energy pulse of the threshold number of energy pulses to maintain the time-averaged voltage within the threshold range.

In some aspects, the threshold number is dynamically configured.

In some aspects, the specialized symbol comprises a NULL symbol.

In some aspects, transmitting the specialized symbol comprises transmitting an inverted version of the at least one energy pulse of the threshold number of energy pulses.

In some aspects, taking the one or more actions comprises: determining that a threshold number of energy pulses having a same pulse width as each other are to be transmitted contiguously; and transmitting an indication to the second wireless communication device, indicating to the second wireless communication device to adjust the time-averaged voltage.

In some aspects, transmitting the indication to adjust the time-averaged voltage comprises transmitting the indication prior to transmitting the threshold number of energy pulses; and the indication indicates to the second wireless communication device to adjust the time-averaged voltage prior to receiving the threshold number of energy pulses.

In some aspects, the indication is transmitted in the RF signals as one of a specialized symbol or a specialized sequence of energy pulses.

In some aspects, the method 1700 further includes receiving, from the second wireless communication device, capability information indicating an ability of the second wireless communication device to adjust the time-averaged voltage, wherein transmitting the indication to adjust the time-averaged voltage is based on the capability information from the second wireless communication device. In some cases, the operations of this step refer to, or may be performed by, circuitry for receiving and/or code for receiving as described with reference to FIG. 19.

In some aspects, the taking one or more actions to maintain the time-averaged voltage associated with the RF signals comprises performing one of data scrambling or data whitening on the RF signals to avoid a threshold number of energy pulses having a same pulse width being transmitted contiguously.

In some aspects, the method 1700 further includes dynamically configuring the encoding scheme used to encode the energy pulses of the RF signals. In some cases, the operations of this step refer to, or may be performed by, circuitry for dynamically and/or code for dynamically as described with reference to FIG. 19.

In some aspects, the method 1700 further includes receiving, from the second wireless communication device, capability information indicating an ability of the second wireless communication device to adjust the time-averaged voltage, wherein dynamically configuring the encoding scheme is based, at least in part, on the capability information. In some cases, the operations of this step refer to, or may be performed by, circuitry for receiving and/or code for receiving as described with reference to FIG. 19.

In some aspects, when the capability information indicates that the second wireless communication device does not support adjusting the time-averaged voltage, taking the one or more actions to maintain a time-averaged voltage associated with the RF signals within the threshold range comprises dynamically configuring a direct current (DC)-balanced encoding scheme to indicate the binary values.

In some aspects, the method 1700 further includes transmitting, to the second wireless communication device, an indication of the dynamically configured encoding scheme. In some cases, the operations of this step refer to, or may be performed by, circuitry for transmitting and/or code for transmitting as described with reference to FIG. 19.

In some aspects, the method 1700 further includes transmitting, in the RF signals, a specialized symbol that indicates to the second wireless communication device to suspend, for a duration,. In some cases, the operations of this step refer to, or may be performed by, circuitry for transmitting and/or code for transmitting as described with reference to FIG. 19.

In some aspects, the method 1700 further includes power averaging of the energy pulses in the RF signals when a threshold number of energy pulses, having a same pulse width, are transmitted contiguously. In some cases, the operations of this step refer to, or may be performed by, circuitry for power and/or code for power as described with reference to FIG. 19.

In some aspects, the method 1700 further includes transmitting, to the second wireless communication device, an indication of the threshold number of energy pulses and an indication of the duration. In some cases, the operations of this step refer to, or may be performed by, circuitry for transmitting and/or code for transmitting as described with reference to FIG. 19.

In some aspects, the method 1700 further includes measuring a response power of the second wireless communication device based on the RF signals transmitted to the second wireless communication device. In some cases, the operations of this step refer to, or may be performed by, circuitry for measuring and/or code for measuring as described with reference to FIG. 19.

In some aspects, the method 1700 further includes dynamically configuring RF ON and RF OFF durations associated with the RF signals, based on the measured response power. In some cases, the operations of this step refer to, or may be performed by, circuitry for dynamically and/or code for dynamically as described with reference to FIG. 19.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

### Example Operations of a Second Wireless Communication Device

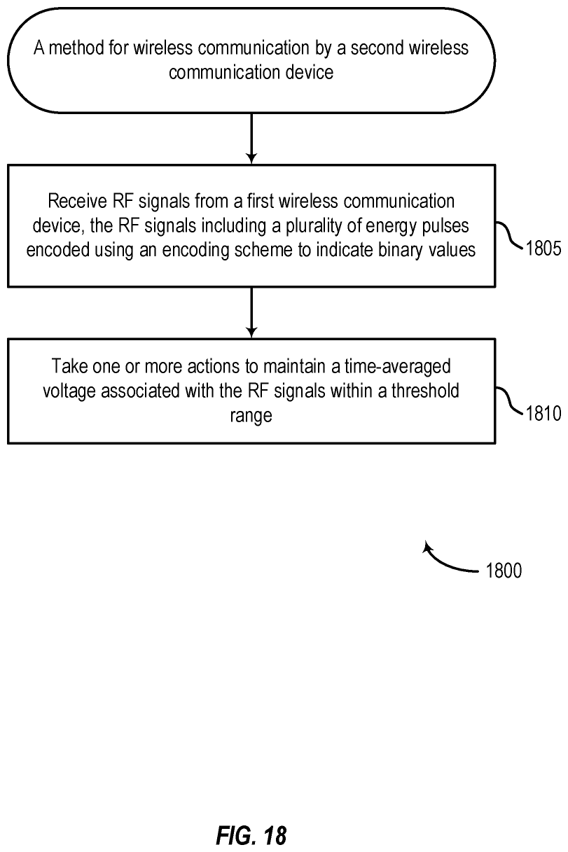

FIG. 18 shows an example of a method 1800 for wireless communication by a second wireless communication device. In some examples, the second wireless communication device is a UE, such as a UE 104 of FIGS. 1 and 3. In some examples, the second wireless communication device is a network entity, such as a BS 102 of FIGS. 1 and 3, or a disaggregated base station as discussed with respect to FIG. 2.

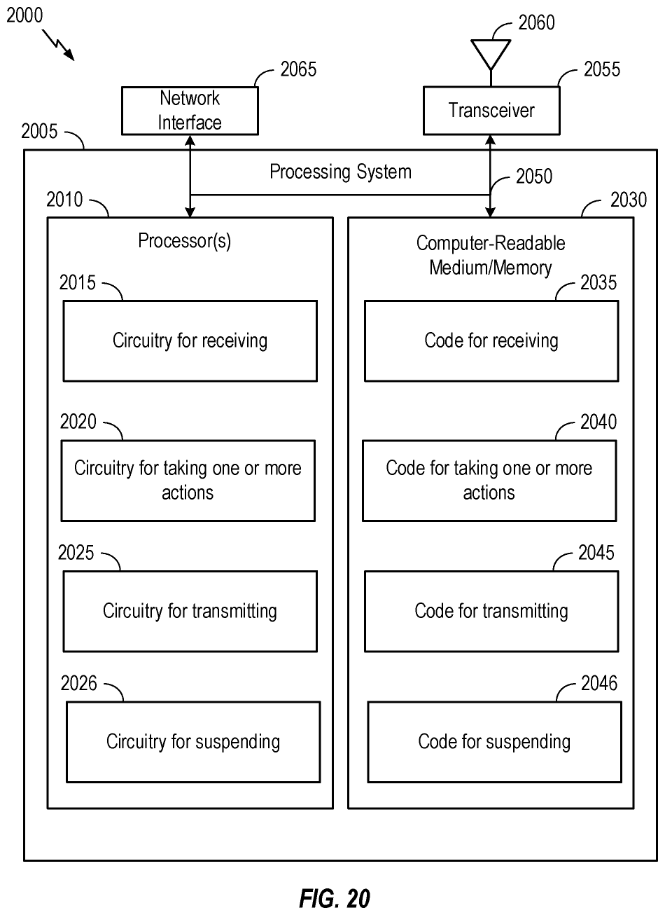

Method 1800 begins at step 1805 with receiving RF signals from a first wireless communication device, the RF signals including a plurality of energy pulses encoded, using an encoding scheme, to indicate binary values. In some cases, the operations of this step refer to, or may be performed by, circuitry for receiving and/or code for receiving as described with reference to FIG. 20.

Method 1800 then proceeds to step 1810 with taking one or more actions to maintain a time-averaged voltage associated with the RF signals within a threshold range. In some cases, the operations of this step refer to, or may be performed by, circuitry for taking and/or code for taking as described with reference to FIG. 20.

In some aspects, based on the encoding scheme, the energy pulses have different pulse widths to indicate the binary values.

In some aspects, the encoding scheme comprises a PIE scheme.

In some aspects, the plurality of energy pulses include a threshold number of energy pulses having a same pulse width as each other; and the method 1800 further comprises receiving a specialized symbol in the RF signals in place of at least one energy pulse of the threshold number of energy pulses to maintain the time-averaged voltage within the threshold range.

In some aspects, the threshold number is dynamically configured.

In some aspects, the specialized symbol comprises a NULL symbol.

In some aspects, receiving the specialized symbol comprises receiving an inverted version of the at least one energy pulse of the threshold number of energy pulses.

In some aspects, the plurality of energy pulses includes a threshold number of energy pulses having a same pulse width; and taking the one or more actions comprises: receiving an indication from the first wireless communication device, indicating to adjust the time-averaged voltage; and adjusting the time-averaged voltage based on the received indication.

In some aspects, receiving the indication to adjust the time-averaged voltage comprises receiving the indication prior to receiving the threshold number of energy pulses; the indication indicates to adjust the time-averaged voltage prior to receiving the threshold number of energy pulses; and adjusting the time-averaged voltage comprises adjusting the time-averaged voltage prior to receiving the threshold number of energy pulses.

In some aspects, the indication is received in the RF signals as one of a specialized symbol or a specialized sequence of energy pulses.

In some aspects, the method 1800 further includes transmitting, to the first wireless communication device, capability information indicating an ability of the second wireless communication device to adjust the time-averaged voltage, wherein receiving the indication to adjust the time-averaged voltage is based on the capability information. In some cases, the operations of this step refer to, or may be performed by, circuitry for transmitting and/or code for transmitting as described with reference to FIG. 20.

In some aspects, the encoding scheme used to encode the energy pulses of the RF signals is dynamically configured.

In some aspects, the method 1800 further includes transmitting, to the first wireless communication device, capability information indicating an ability of the second wireless communication device to adjust the time-averaged voltage, wherein the dynamically configured encoding scheme is based, at least in part, on the capability information. In some cases, the operations of this step refer to, or may be performed by, circuitry for transmitting and/or code for transmitting as described with reference to FIG. 20.

In some aspects, when the capability information indicates that the second wireless communication device does not support adjusting the time-averaged voltage, the plurality of energy pulses are encoded with a direct current (DC)-balanced encoding scheme to indicate the binary values.

In some aspects, the method 1800 further includes receiving, from the first wireless communication device, an indication of the dynamically configured encoding scheme. In some cases, the operations of this step refer to, or may be performed by, circuitry for receiving and/or code for receiving as described with reference to FIG. 20.

In some aspects, the method 1800 further includes receiving, in the RF signals, a specialized symbol that indicates to suspend, for a duration, power averaging of the energy pulses in the RF signals when a threshold number of energy pulses, having a same pulse width, are received contiguously, wherein the taking the one or more actions comprises suspending the power averaging of the energy pulses in the RF signals for the duration. In some cases, the operations of this step refer to, or may be performed by, circuitry for receiving and/or code for receiving as described with reference to FIG. 20.

In some aspects, the method 1800 further includes receiving, from the first wireless communication device, an indication of the threshold number of energy pulses and an indication of the duration. In some cases, the operations of this step refer to, or may be performed by, circuitry for receiving and/or code for receiving as described with reference to FIG. 20.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

### Example Communication Devices

FIG. 19 depicts aspects of an example communications device 1900. In some aspects, communications device 1900 is a user equipment, such as a UE 104 described above with respect to FIGS. 1 and 3. In some aspects, communications device 1900 is a network entity, such as a BS 102 of FIGS. 1 and 3, or a disaggregated base station as discussed with respect to FIG. 2.

The communications device 1900 includes a processing system 1905 coupled to the transceiver 1975 (e.g., a transmitter and/or a receiver). In some aspects (e.g., when communications device 1900 is a network entity), processing system 1905 may be coupled to a network interface 1985 that is configured to obtain and send signals for the communications device 1900 via communication link(s), such as a backhaul link, midhaul link, and/or fronthaul link as described herein, such as with respect to FIG. 2. The transceiver 1975 is configured to transmit and receive signals for the communications device 1900 via the antenna 1980, such as the various signals as described herein. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 358, transmit processor 364, TX MIMO processor 366, and/or controller/processor 380, as described with respect to FIG. 3. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1940 via a bus 1970. In certain aspects, the computer-readable medium/memory 1940 is configured to store instructions (e.g., computer-executable code) that when executed by the one or more processors 1910, cause the one or more processors 1910 to perform the method 1700 described with respect to FIG. 17, or any aspect related to it. Note that reference to a processor performing a function of communications device 1900 may include one or more processors 1910 performing that function of communications device 1900.

In the depicted example, computer-readable medium/memory 1940 stores code (e.g., executable instructions), such as code for transmitting 1945, code for taking 1950, code for receiving 1955, code for dynamically configuring 1960, and code for measuring 1965. Processing of the code for transmitting 1945, code for taking 1950, code for receiving 1955, code for dynamically configuring 1960, and code for measuring 1965 may cause the communications device 1900 to perform the method 1700 described with respect to FIG. 17, or any aspect related to it.

The one or more processors 1910 include circuitry configured to implement (e.g., execute) the code stored in the computer-readable medium/memory 1940, including circuitry such as circuitry for transmitting 1915, circuitry for taking 1920, circuitry for receiving 1925, circuitry for dynamically configuring 1930, and circuitry for measuring 1935. Processing with circuitry for transmitting 1915, circuitry for taking 1920, circuitry for receiving 1925, circuitry for dynamically configuring 1930, and circuitry for measuring 1935 may cause the communications device 1900 to perform the method 1700 described with respect to FIG. 17, or any aspect related to it.

Various components of the communications device 1900 may provide means for performing the method 1700 described with respect to FIG. 17, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1975 and the antenna 1980 of the communications device 1900 in FIG. 19. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1975 and the antenna 1980 of the communications device 1900 in FIG. 19.

FIG. 20 depicts aspects of an example communications device 2000. In some aspects, communications device 2000 is a user equipment, such as UE 104 described above with respect to FIGS. 1 and 3. In some aspects, communications device 2000 is a network entity, such as BS 102 of FIGS. 1 and 3, or a disaggregated base station as discussed with respect to FIG. 2.

The communications device 2000 includes a processing system 2005 coupled to the transceiver 2055 (e.g., a transmitter and/or a receiver). In some aspects (e.g., when communications device 2000 is a network entity), processing system 2005 may be coupled to a network interface 2065 that is configured to obtain and send signals for the communications device 2000 via communication link(s), such as a backhaul link, midhaul link, and/or fronthaul link as described herein, such as with respect to FIG. 2. The transceiver 2055 is configured to transmit and receive signals for the communications device 2000 via the antenna 2060, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2030 via a bus 2050. In certain aspects, the computer-readable medium/memory 2030 is configured to store instructions (e.g., computer-executable code) that when executed by the one or more processors 2010, cause the one or more processors 2010 to perform the method 1800 described with respect to FIG. 18, or any aspect related to it. Note that reference to a processor performing a function of communications device 2000 may include one or more processors 2010 performing that function of communications device 2000.

In the depicted example, computer-readable medium/memory 2030 stores code (e.g., executable instructions), such as code for receiving 2035, code for taking 2040, code for transmitting 2045, and code for suspending 2046. Processing of the code for receiving 2035, code for taking 2040, code for transmitting 2045, and code for suspending 2046 may cause the communications device 2000 to perform the method 1800 described with respect to FIG. 18, or any aspect related to it.

The one or more processors 2010 include circuitry configured to implement (e.g., execute) the code stored in the computer-readable medium/memory 2030, including circuitry such as circuitry for receiving 2015, circuitry for taking 2020, circuitry for transmitting 2025, and circuitry 2026 for suspending. Processing with circuitry for receiving 2015, circuitry for taking 2020, circuitry for transmitting 2025, and circuitry 2026 for suspending may cause the communications device 2000 to perform the method 1800 described with respect to FIG. 18, or any aspect related to it.

Various components of the communications device 2000 may provide means for performing the method 1800 described with respect to FIG. 18, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2055 and the antenna 2060 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2055 and the antenna 2060 of the communications device 2000 in FIG. 20.

### EXAMPLE CLAUSES

Implementation examples are described in the following numbered clauses:
Clause 1: A method for wireless communication by a first wireless communication device, comprising: transmitting RF signals to a second wireless communication device, the RF signals including a plurality of energy pulses encoded, using an encoding scheme, to indicate binary values; and taking one or more actions to maintain a time-averaged voltage associated with the RF signals within a threshold range.
Clause 2: The method of Clause 1, wherein, based on the encoding scheme, the energy pulses have different pulse widths to indicate the binary values.
Clause 3: The method of any one of Clauses 1-2, wherein the encoding scheme comprises a PIE scheme.
Clause 4: The method of any one of Clauses 1-3, wherein the taking one or more actions comprises: determining that a threshold number of energy pulses having a same pulse width as each other are to be transmitted contiguously; and transmitting, based on the determined threshold number of energy pulses, a specialized symbol in the RF signals in place of at least one energy pulse of the threshold number of energy pulses to maintain the time-averaged voltage within the threshold range.
Clause 5: The method of Clause 4, wherein the threshold number is dynamically configured.
Clause 6: The method of Clause 4, wherein the specialized symbol comprises a NULL symbol.
Clause 7: The method of Clause 4, wherein transmitting the specialized symbol comprises transmitting an inverted version of the at least one energy pulse of the threshold number of energy pulses.
Clause 8: The method of any one of Clauses 1-7, wherein the taking the one or more actions comprises: determining that a threshold number of energy pulses having a same pulse width as each other are to be transmitted contiguously; and transmitting an indication to the second wireless communication device, indicating to the second wireless communication device to adjust the time-averaged voltage.
Clause 9: The method of Clause 8, wherein: transmitting the indication to adjust the time-averaged voltage comprises transmitting the indication prior to transmitting the threshold number of energy pulses; and the indication indicates to the second wireless communication device to adjust the time-averaged voltage prior to receiving the threshold number of energy pulses.
Clause 10: The method of any one of Clauses 8-9, wherein the indication is transmitted in the RF signals as one of a specialized symbol or a specialized sequence of energy pulses.
Clause 11: The method of any one of Clauses 8-10, further comprising: receiving, from the second wireless communication device, capability information indicating an ability of the second wireless communication device to adjust the time-averaged voltage, wherein transmitting the indication to adjust the time-averaged voltage is based on the capability information from the second wireless communication device.
Clause 12: The method of any one of Clauses 1-11, wherein the taking one or more actions to maintain the time-averaged voltage associated with the RF signals comprises performing one of data scrambling or data whitening on the RF signals to avoid a threshold number of energy pulses having a same pulse width being transmitted contiguously.
Clause 13: The method of any one of Clauses 1-12, further comprising: dynamically configuring the encoding scheme used to encode the energy pulses of the RF signals.
Clause 14: The method of Clause 13, further comprising: receiving, from the second wireless communication device, capability information indicating an ability of the second wireless communication device to adjust the time-averaged voltage, wherein dynamically configuring the encoding scheme is based, at least in part, on the capability information.
Clause 15: The method of Clause 14, wherein, when the capability information indicates that the second wireless communication device does not support adjusting the time-averaged voltage, taking the one or more actions to maintain the time-averaged voltage associated with the RF signals within the threshold range comprises dynamically configuring a direct current (DC)-balanced encoding scheme to indicate the binary values.
Clause 16: The method of any one of Clauses 13-15, further comprising: transmitting, to the second wireless communication device, an indication of the dynamically configured encoding scheme.
Clause 17: The method of any one of Clauses 1-16, further comprising: transmitting, in the RF signals, a specialized symbol that indicates to the second wireless communication device to suspend, for a duration and power averaging of the energy pulses in the RF signals when a threshold number of energy pulses, having a same pulse width, are transmitted contiguously.
Clause 18: The method of Clause 17, further comprising: transmitting, to the second wireless communication device, an indication of the threshold number of energy pulses and an indication of the duration.
Clause 19: The method of any one of Clauses 1-18, further comprising: measuring a response power of the second wireless communication device based on the RF signals transmitted to the second wireless communication device and dynamically configuring RF ON and RF OFF durations associated with the RF signals, based on the measured response power.
Clause 20: A method for wireless communication by a second wireless communication device, comprising: receiving RF signals from a first wireless communication device, the RF signals including a plurality of energy pulses encoded, using an encoding scheme, to indicate binary values; and taking one or more actions to maintain a time-averaged voltage associated with the RF signals within a threshold range.
Clause 21: The method of Clause 20, wherein, based on the encoding scheme, the energy pulses have different pulse widths to indicate the binary values.
Clause 22: The method of any one of Clauses 20-21, wherein the encoding scheme comprises a PIE scheme.
Clause 23: The method of any one of Clauses 20-22, wherein: the plurality of energy pulses include a threshold number of energy pulses having a same pulse width as each other; and the method further comprises receiving a specialized symbol in the RF signals in place of at least one energy pulse of the threshold number of energy pulses to maintain the time-averaged voltage within the threshold range.
Clause 24: The method of Clause 23, wherein the threshold number is dynamically configured.
Clause 25: The method of any one of Clauses 23-24, wherein the specialized symbol comprises a NULL symbol.
Clause 26: The method of any one of Clauses 23-25, wherein receiving the specialized symbol comprises receiving an inverted version of the at least one energy pulse of the threshold number of energy pulses.
Clause 27: The method of any one of Clauses 20-26, wherein: the plurality of energy pulses includes a threshold number of energy pulses having a same pulse width; and taking the one or more actions comprises: receiving an indication from the first wireless communication device, indicating to adjust the time-averaged voltage; and adjusting the time-averaged voltage based on the received indication.
Clause 28: The method of Clause 27, wherein: receiving the indication to adjust the time-averaged voltage comprises receiving the indication prior to receiving the threshold number of energy pulses; the indication indicates to adjust the time-averaged voltage prior to receiving the threshold number of energy pulses; and adjusting the time-averaged voltage adjustment comprises adjusting the time-averaged voltage prior to receiving the threshold number of energy pulses.
Clause 29: The method of any one of Clauses 27-28, wherein the indication is received in the RF signals as one of a specialized symbol or a specialized sequence of energy pulses.
Clause 30: The method of any one of Clauses 27, further comprising: transmitting, to the first wireless communication device, capability information indicating an ability of the second wireless communication device to adjust the time-averaged voltage, wherein receiving the indication to adjust the time-averaged voltage is based on the capability information.
Clause 31: The method of any one of Clauses 20-30, wherein the encoding scheme used to encode the energy pulses of the RF signals is dynamically configured.
Clause 32: The method of Clause 31, further comprising: transmitting, to the first wireless communication device, capability information indicating an ability of the second wireless communication device to adjust the time-averaged voltage, wherein the dynamically configured encoding scheme is based, at least in part, on the capability information.
Clause 33: The method of Clause 32, wherein, when the capability information indicates that the second wireless communication device does not support adjusting the time-averaged voltage, the plurality of energy pulses are encoded with a direct current (DC)-balanced encoding scheme to indicate the binary values.
Clause 34: The method of any one of Clauses 31-33, further comprising: receiving, from the first wireless communication device, an indication of the dynamically configured encoding scheme.
Clause 35: The method of any one of Clauses 20-34, further comprising: receiving, in the RF signals, a specialized symbol that indicates to suspend, for a duration, power averaging of the energy pulses in the RF signals when a threshold number of energy pulses, having a same pulse width, are received contiguously, wherein the taking the one or more actions comprises suspending the power averaging of the energy pulses in the RF signals for the duration.
Clause 36: The method of Clause 35, further comprising: receiving, from the first wireless communication device, an indication of the threshold number of energy pulses and an indication of the duration.
Clause 37: An apparatus, comprising: a memory comprising executable instructions; and a processor configured to execute the executable instructions and cause the apparatus to perform a method in accordance with any one of Clauses 1-36.
Clause 38: An apparatus, comprising means for performing a method in accordance with any one of Clauses 1-36.
Clause 39: A non-transitory computer-readable medium comprising executable instructions that, when executed by a processor of an apparatus, cause the apparatus to perform a method in accordance with any one of Clauses 1-36.
Clause 40: A computer program product embodied on a computer-readable storage medium comprising code for performing a method in accordance with any one of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S. C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communication by a first wireless communication device, comprising:
transmitting radio frequency (RF) signals to a second wireless communication device, the RF signals including a plurality of energy pulses encoded, using an encoding scheme, to indicate binary values; and
taking one or more actions to maintain a time-averaged voltage associated with the RF signals within a threshold range.

2. The method of claim 1, wherein, based on the encoding scheme, the energy pulses have a first pulse width to indicate a first binary value and a second pulse width to indicate a second binary value.

3. The method of claim 1, wherein the encoding scheme comprises a pulse interval encoding (PIE) scheme.

4. The method of claim 2, wherein the taking one or more actions comprises:
determining that a threshold number of energy pulses having a same pulse width as each other are to be transmitted contiguously; and
transmitting, based on the determined threshold number of energy pulses, a specialized symbol in the RF signals in place of at least one energy pulse of the threshold number of energy pulses to maintain the time-averaged voltage within the threshold range.

5. The method of claim 4, wherein the threshold number is dynamically configured.

6. The method of claim 4, wherein the specialized symbol comprises a NULL symbol.

7. The method of claim 4, wherein transmitting the specialized symbol comprises transmitting an inverted version of the at least one energy pulse of the threshold number of energy pulses.

8. The method of claim 2, wherein the taking the one or more actions comprises:
determining that a threshold number of energy pulses having a same pulse width as each other are to be transmitted contiguously; and
transmitting an indication to the second wireless communication device, indicating to the second wireless communication device to adjust the time-averaged voltage.

9. The method of claim 8, wherein:
transmitting the indication to adjust the time-averaged voltage comprises transmitting the indication prior to transmitting the threshold number of energy pulses; and
the indication indicates to the second wireless communication device to adjust the time-averaged voltage prior to receiving the threshold number of the same contiguous energy pulses.

10. The method of claim 8, wherein the indication is transmitted in the RF signals as one of a specialized symbol or a specialized sequence of energy pulses.

11. The method of claim 8, further comprising:
receiving, from the second wireless communication device, capability information indicating an ability of the second wireless communication device to adjust the time-averaged voltage, wherein transmitting the indication to adjust the time-averaged voltage is based on the capability information from the second wireless communication device.

12. The method of claim 2, wherein the taking one or more actions to maintain the time-averaged voltage associated with the RF signals comprises:
performing one of data scrambling or data whitening on the RF signals to avoid a threshold number of energy pulses having a same pulse width being transmitted contiguously.

13. The method of claim 1, further comprising dynamically configuring the encoding scheme used to encode the energy pulses of the RF signals.

14. The method of claim 13, further comprising:
receiving, from the second wireless communication device, capability information indicating an ability of the second wireless communication device to adjust the time-averaged voltage, wherein the dynamically configuring the encoding scheme is based, at least in part, on the capability information.

15. The method of claim 14, wherein, when the capability information indicates that the second wireless communication device does not support adjusting the time-averaged voltage, the taking the one or more actions to maintain the time-averaged voltage associated with the RF signals within the threshold range comprises dynamically configuring a direct current (DC)-balanced encoding scheme to indicate the binary values.

16. The method of claim 13, further comprising transmitting, to the second wireless communication device, an indication of the dynamically configured encoding scheme.

17. The method of claim 2, further comprising:
transmitting, in the RF signals, a specialized symbol that indicates to the second wireless communication device to suspend, for a duration, power averaging of the energy pulses in the RF signals when a threshold number of energy pulses, having a same pulse width, are transmitted contiguously; and
transmitting, to the second wireless communication device, an indication of the threshold number of energy pulses and an indication of the duration.

18. The method of claim 1, further comprising:
measuring a response power of the second wireless communication device based on the RF signals transmitted to the second wireless communication device; and
dynamically configuring RF ON and RF OFF durations associated with the RF signals, based on the measured response power.

19. A method for wireless communication by a second wireless communication device, comprising:
receiving radio frequency (RF) signals from a first wireless communication device, the RF signals including a plurality of energy pulses encoded, using an encoding scheme, to indicate binary values; and
taking one or more actions to maintain a time-averaged voltage associated with the RF signals within a threshold range.

20. The method of claim 19, wherein, based on the encoding scheme, the energy pulses have a first pulse width to indicate a first binary value and a second pulse width to indicate a second binary value.

21-30. (canceled)
